(19) United States
(12) Patent Application Publication
(10) Pub. No.: US 2026/0135999 A1
(43) Pub. Date: May 14, 2026

(54) EXTENDED ANGULAR PREDICTION MODES WITH DECODER SIDE REFINEMENT

(71) Applicant: InterDigital CE Patent Holdings, SAS, Paris (FR)

(72) Inventors: Karam Naser, Mouazé (FR); Gagan Bihari Rath, Rennes (FR); Kevin Reuzé, Rennes (FR); Thierry Dumas, Rennes (FR)

(73) Assignee: InterDigital CE Patent Holdings, SAS, Paris (FR)

(21) Appl. No.: 19/119,047

(22) PCT Filed: Oct. 11, 2023
(86) PCT No.: PCT/EP2023/078202

§ 371 Date: Apr. 7, 2025

(30) Foreign Application Priority Data
Oct. 11, 2022 (EP) 22306532.7

(51) Int. Cl. H04N 19/11; H04N 19/159; H04N 19/176; H04N 19/593

(52) U.S. Cl. CPC H04N 19/11; H04N 19/159; H04N 19/176; H04N 19/593

(57) ABSTRACT

Systems, methods, and instrumentalities are disclosed for refining extended angular prediction modes. A device (e.g., a video decoding device) may receive, for a video block, an indication of a first intra prediction mode associated with a first resolution. Based on the first intra prediction mode, the device may identify a second intra prediction mode associated with a second resolution. The device may evaluate the first intra prediction mode and the second intra prediction mode on a template of the video block. The device may select, among the first intra prediction mode and the second intra prediction mode, a refined intra prediction mode for the video block. The device may decode the video block based on the refined intra prediction mode.

### CROSS REFERENCE TO RELATED APPLICATIONS

This application claims the benefit of European Provisional Patent Application No. 22306532.7, filed Oct. 11, 2022, the contents of which are hereby incorporated by reference herein.

### BACKGROUND

Video coding systems can be used to compress digital video signals, e.g., to reduce the storage and/or transmission bandwidth needed for such signals. Video coding systems can include, for example, block-based, wavelet-based, and/or object-based systems.

### SUMMARY

Systems, methods, and instrumentalities are disclosed for refining extended angular prediction modes. A device (e.g., a video decoding device) may determine, for a video block, a first intra prediction mode associated with a first resolution. For example, the first intra prediction mode associated with the first resolution may be determined based on an intra prediction mode indication associated with the video block in video data (e.g., a video bitstream). Based on the first intra prediction mode, the device may identify a second intra prediction mode associated with a second resolution. The second resolution may be higher than the first resolution. The device may evaluate the first intra prediction mode and the second intra prediction mode on a template of the video block. The device may select, among the first intra prediction mode and the second intra prediction mode, a refined intra prediction mode for the video block. The device may decode the video block based on the refined intra prediction mode.

For example, the device may identify a third intra prediction mode associated with the second (e.g., higher resolution). The device may compute respective predictions of the reconstructed template of the video block based on the three intra prediction modes. The device may select the refined intra prediction mode among the intra prediction of the first resolution and the two intra prediction modes of the second resolution for the video block based on their respective prediction errors. The refined intra prediction mode may be selected based on a determination that a prediction error of the refined intra prediction mode is lowest among the prediction errors when used to predict the template of the video block.

The device may generate a histogram of gradients on the template of the video block. The histogram may include directions associated with the first intra prediction mode, the second intra prediction mode, and the third intra prediction mode. The device may select, among the first intra prediction mode, the second intra prediction mode, and the third intra prediction mode, the refined intra mode based on their associated histogram amplitude values. The refined intra prediction mode may be selected based on a determination that a histogram amplitude value that corresponds to the refined intra prediction mode is the highest among the histogram amplitude values.

A device (e.g., a video encoding device) may determine, for a video block, a first intra prediction mode associated with a first resolution. For example, the first intra prediction mode associated with the first resolution may be determined based on an intra prediction mode indication associated with the video block in video data (e.g., a video bitstream). Based on the first intra prediction mode, the device may identify a second intra prediction mode associated with a second resolution. The second resolution may be higher than the first resolution. The device may evaluate the first intra prediction mode and the second intra prediction mode on a template of the video block. The device may select, among the first intra prediction mode and the second intra prediction mode, a refined intra prediction mode for the video block. The device may decode the video block based on the refined intra prediction mode.

For example, the device may identify a third intra prediction mode associated with the second (e.g., higher resolution). The device may compute respective predictions of the reconstructed template of the video block based on the three intra prediction modes. The device may select the refined intra prediction mode among the intra prediction of the first resolution and the two intra prediction modes of the second resolution for the video block based on their respective prediction errors. The refined intra prediction mode may be selected based on a determination that a prediction error of the refined intra prediction mode is lowest among the prediction errors when used to predict the template of the video block.

The device may generate a histogram of gradients on the template of the video block. The histogram may include directions associated with the first intra prediction mode, the second intra prediction mode, and the third intra prediction mode. The device may select, among the first intra prediction mode, the second intra prediction mode, and the third intra prediction mode, the refined intra mode based on their associated histogram amplitude values. The refined intra prediction mode may be selected based on a determination that a histogram amplitude value that corresponds to the refined intra prediction mode is the highest among the histogram amplitude values.

Systems, methods, and instrumentalities described herein can involve a decoder. In some examples, the systems, methods, and instrumentalities described herein can involve an encoder. In some examples, the systems, methods, and instrumentalities described herein can involve a signal (e.g., from an encoder and/or received by a decoder). A computer-readable medium can include instructions for causing one or more processors to perform methods described herein. A computer program product can include instructions which, when the program is executed by one or more processors, can cause the one or more processors to carry out the methods described herein.

### BRIEF DESCRIPTION OF THE DRAWINGS

FIG. 1A is a system diagram illustrating an example communications system in which one or more disclosed embodiments can be implemented.

FIG. 1B is a system diagram illustrating an example wireless transmit/receive unit (WTRU) that can be used within the communications system illustrated in FIG. 1A according to an embodiment.

FIG. 1C is a system diagram illustrating an example radio access network (RAN) and an example core network (CN) that can be used within the communications system illustrated in FIG. 1A according to an embodiment.

FIG. 1D is a system diagram illustrating a further example RAN and a further example CN that can be used within the communications system illustrated in FIG. 1A according to an embodiment.

FIG. 2 illustrates an example video encoder.

FIG. 3 illustrates an example video decoder.

FIG. 4 illustrates an example of a a system in which various aspects and examples can be implemented.

FIG. 5 shows an example of prediction modes and prediction directions.

FIG. 6 shows an example of a template of a current luminance and decoded reference samples of the template.

FIG. 7 shows neighboring reconstructed samples used, for example, for decoder side intra mode derivation (DIMD) chroma mode.

FIG. 8 illustrates an example block diagram for refinement.

### DETAILED DESCRIPTION

A more detailed understanding can be had from the following description, given by way of example in conjunction with the accompanying drawings.

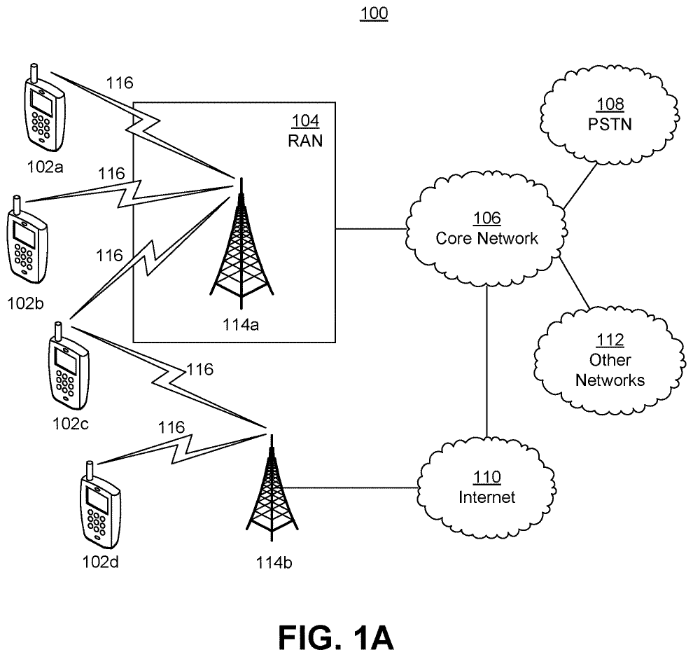

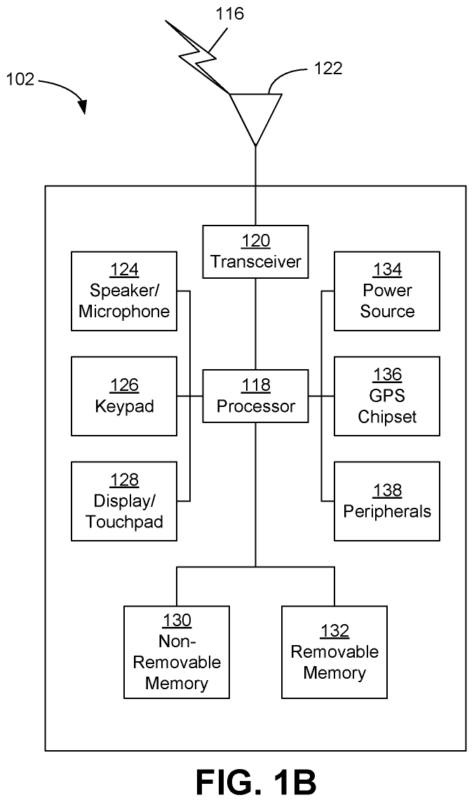

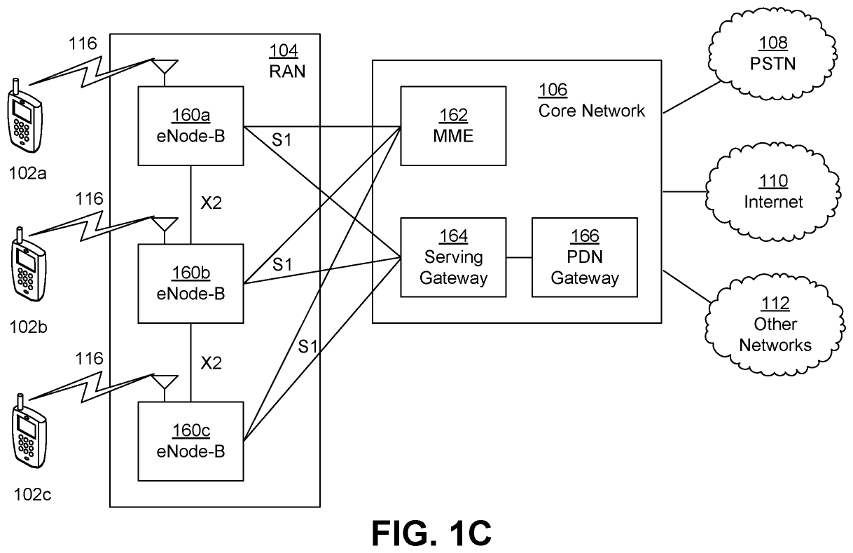

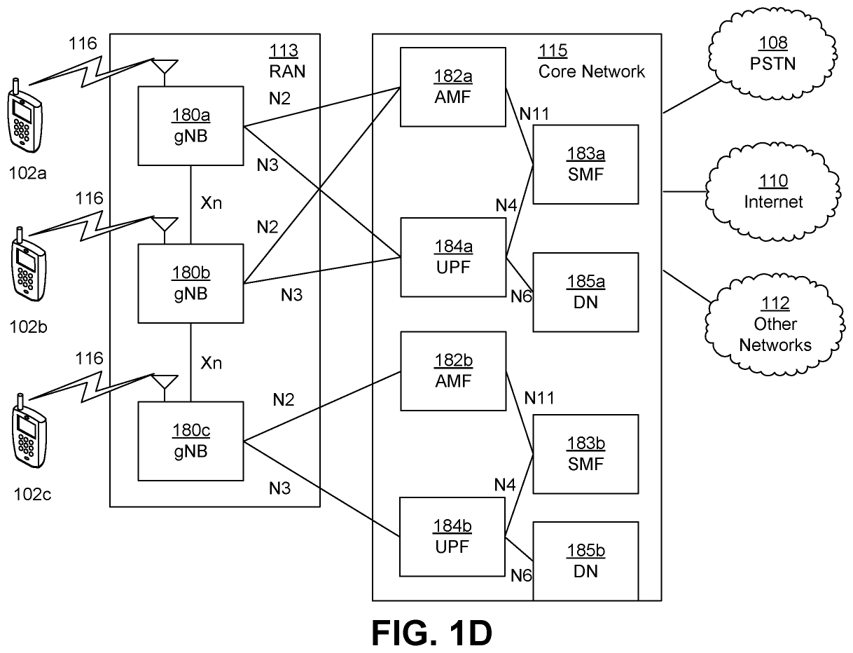

FIG. 1A is a diagram illustrating an example communications system 100 in which one or more disclosed embodiments can be implemented. The communications system 100 can be a multiple access system that provides content, such as voice, data, video, messaging, broadcast, etc., to multiple wireless users. The communications system 100 can enable multiple wireless users to access such content through the sharing of system resources, including wireless bandwidth. For example, the communications systems 100 can employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 can include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d can be any type of device configured to operate and/or communicate in a wireless environment. By way of example, the WTRUs 102a, 102b, 102c, 102d, any of which can be referred to as a “station” and/or a “STA”, can be configured to transmit and/or receive wireless signals and can include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d can be interchangeably referred to as a UE.

The communications systems 100 can also include a base station 114a and/or a base station 114b. Each of the base stations 114a, 114b can be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b can be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b can include any number of interconnected base stations and/or network elements.

The base station 114a can be part of the RAN 104/113, which can also include other base stations and/or network elements (not shown), such as a base station controller (BSC), a radio network controller (RNC), relay nodes, etc. The base station 114a and/or the base station 114b can be configured to transmit and/or receive wireless signals on one or more carrier frequencies, which can be referred to as a cell (not shown). These frequencies can be in licensed spectrum, unlicensed spectrum, or a combination of licensed and unlicensed spectrum. A cell can provide coverage for a wireless service to a specific geographical area that can be relatively fixed or that can change over time. The cell can further be divided into cell sectors. For example, the cell associated with the base station 114a can be divided into three sectors. Thus, in one embodiment, the base station 114a can include three transceivers, i.e., one for each sector of the cell. In an embodiment, the base station 114a can employ multiple-input multiple output (MIMO) technology and can utilize multiple transceivers for each sector of the cell. For example, beamforming can be used to transmit and/or receive signals in desired spatial directions.

The base stations 114a, 114b can communicate with one or more of the WTRUs 102a, 102b, 102c, 102d over an air interface 116, which can be any suitable wireless communication link (e.g., radio frequency (RF), microwave, centimeter wave, micrometer wave, infrared (IR), ultraviolet (UV), visible light, etc.). The air interface 116 can be established using any suitable radio access technology (RAT).

More specifically, as noted above, the communications system 100 can be a multiple access system and can employ one or more channel access schemes, such as CDMA, TDMA, FDMA, OFDMA, SC-FDMA, and the like. For example, the base station 114a in the RAN 104/113 and the WTRUs 102a, 102b, 102c can implement a radio technology such as Universal Mobile Telecommunications System (UMTS) Terrestrial Radio Access (UTRA), which can establish the air interface 115/116/117 using wideband CDMA (WCDMA). WCDMA can include communication protocols such as High-Speed Packet Access (HSPA) and/or Evolved HSPA (HSPA+). HSPA can include High-Speed Downlink (DL) Packet Access (HSDPA) and/or High-Speed UL Packet Access (HSUPA).

In an embodiment, the base station 114a and the WTRUs 102a, 102b, 102c can implement a radio technology such as Evolved UMTS Terrestrial Radio Access (E-UTRA), which can establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c can implement a radio technology such as NR Radio Access, which can establish the air interface 116 using New Radio (NR).

In an embodiment, the base station 114a and the WTRUs 102a, 102b, 102c can implement multiple radio access technologies. For example, the base station 114a and the WTRUs 102a, 102b, 102c can implement LTE radio access and NR radio access together, for instance using dual connectivity (DC) principles. Thus, the air interface utilized by WTRUs 102a, 102b, 102c can be characterized by multiple types of radio access technologies and/or transmissions sent to/from multiple types of base stations (e.g., an eNB and a gNB).

In other embodiments, the base station 114a and the WTRUs 102a, 102b, 102c can implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A can be a wireless router, Home Node B, Home eNode B, or access point, for example, and can utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d can implement a radio technology such as IEEE 802.11 to establish a wireless local area network (WLAN). In an embodiment, the base station 114b and the WTRUs 102c, 102d can implement a radio technology such as IEEE 802.15 to establish a wireless personal area network (WPAN). In yet another embodiment, the base station 114b and the WTRUs 102c, 102d can utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b can have a direct connection to the Internet 110. Thus, the base station 114b may not be required to access the Internet 110 via the CN 106/115.

The RAN 104/113 can be in communication with the CN 106/115, which can be any type of network configured to provide voice, data, applications, and/or voice over internet protocol (VoIP) services to one or more of the WTRUs 102a, 102b, 102c, 102d. The data can have varying quality of service (QOS) requirements, such as differing throughput requirements, latency requirements, error tolerance requirements, reliability requirements, data throughput requirements, mobility requirements, and the like. The CN 106/115 can provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 can be in direct or indirect communication with other RANs that employ the same RAT as the RAN 104/113 or a different RAT. For example, in addition to being connected to the RAN 104/113, which can be utilizing a NR radio technology, the CN 106/115 can also be in communication with another RAN (not shown) employing a GSM, UMTS, CDMA 2000, WiMAX, E-UTRA, or WiFi radio technology.

The CN 106/115 can also serve as a gateway for the WTRUs 102a, 102b, 102c, 102d to access the PSTN 108, the Internet 110, and/or the other networks 112. The PSTN 108 can include circuit-switched telephone networks that provide plain old telephone service (POTS). The Internet 110 can include a global system of interconnected computer networks and devices that use common communication protocols, such as the transmission control protocol (TCP), user datagram protocol (UDP) and/or the internet protocol (IP) in the TCP/IP internet protocol suite. The networks 112 can include wired and/or wireless communications networks owned and/or operated by other service providers. For example, the networks 112 can include another CN connected to one or more RANs, which can employ the same RAT as the RAN 104/113 or a different RAT.

Some or all of the WTRUs 102a, 102b, 102c, 102d in the communications system 100 can include multi-mode capabilities (e.g., the WTRUs 102a, 102b, 102c, 102d can include multiple transceivers for communicating with different wireless networks over different wireless links). For example, the WTRU 102c shown in FIG. 1A can be configured to communicate with the base station 114a, which can employ a cellular-based radio technology, and with the base station 114b, which can employ an IEEE 802 radio technology.

FIG. 1B is a system diagram illustrating an example WTRU 102. As shown in FIG. 1B, the WTRU 102 can include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 can include any sub-combination of the foregoing elements while remaining consistent with an embodiment.

The processor 118 can be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 can perform signal coding, data processing, power control, input/output processing, and/or any other functionality that enables the WTRU 102 to operate in a wireless environment. The processor 118 can be coupled to the transceiver 120, which can be coupled to the transmit/receive element 122. While FIG. 1B depicts the processor 118 and the transceiver 120 as separate components, it will be appreciated that the processor 118 and the transceiver 120 can be integrated together in an electronic package or chip.

The transmit/receive element 122 can be configured to transmit signals to, or receive signals from, a base station (e.g., the base station 114a) over the air interface 116. For example, in one embodiment, the transmit/receive element 122 can be an antenna configured to transmit and/or receive RF signals. In an embodiment, the transmit/receive element 122 can be an emitter/detector configured to transmit and/or receive IR, UV, or visible light signals, for example. In yet another embodiment, the transmit/receive element 122 can be configured to transmit and/or receive both RF and light signals. It will be appreciated that the transmit/receive element 122 can be configured to transmit and/or receive any combination of wireless signals.

Although the transmit/receive element 122 is depicted in FIG. 1B as a single element, the WTRU 102 can include any number of transmit/receive elements 122. More specifically, the WTRU 102 can employ MIMO technology. Thus, in one embodiment, the WTRU 102 can include two or more transmit/receive elements 122 (e.g., multiple antennas) for transmitting and receiving wireless signals over the air interface 116.

The transceiver 120 can be configured to modulate the signals that are to be transmitted by the transmit/receive element 122 and to demodulate the signals that are received by the transmit/receive element 122. As noted above, the WTRU 102 can have multi-mode capabilities. Thus, the transceiver 120 can include multiple transceivers for enabling the WTRU 102 to communicate via multiple RATs, such as NR and IEEE 802.11, for example.

The processor 118 of the WTRU 102 can be coupled to, and can receive user input data from, the speaker/microphone 124, the keypad 126, and/or the display/touchpad 128 (e.g., a liquid crystal display (LCD) display unit or organic light-emitting diode (OLED) display unit). The processor 118 can also output user data to the speaker/microphone 124, the keypad 126, and/or the display/touchpad 128. In addition, the processor 118 can access information from, and store data in, any type of suitable memory, such as the non-removable memory 130 and/or the removable memory 132. The non-removable memory 130 can include random-access memory (RAM), read-only memory (ROM), a hard disk, or any other type of memory storage device. The removable memory 132 can include a subscriber identity module (SIM) card, a memory stick, a secure digital (SD) memory card, and the like. In other embodiments, the processor 118 can access information from, and store data in, memory that is not physically located on the WTRU 102, such as on a server or a home computer (not shown).

The processor 118 can receive power from the power source 134 and can be configured to distribute and/or control the power to the other components in the WTRU 102. The power source 134 can be any suitable device for powering the WTRU 102. For example, the power source 134 can include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 can also be coupled to the GPS chipset 136, which can be configured to provide location information (e.g., longitude and latitude) regarding the current location of the WTRU 102. In addition to, or in lieu of, the information from the GPS chipset 136, the WTRU 102 can receive location information over the air interface 116 from a base station (e.g., base stations 114a, 114b) and/or determine its location based on the timing of the signals being received from two or more nearby base stations. It will be appreciated that the WTRU 102 can acquire location information by way of any suitable location-determination method while remaining consistent with an embodiment.

The processor 118 can further be coupled to other peripherals 138, which can include one or more software and/or hardware modules that provide additional features, functionality and/or wired or wireless connectivity. For example, the peripherals 138 can include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 can include one or more sensors, the sensors can be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 can include a full duplex radio for which transmission and reception of some or all of the signals (e.g., associated with particular subframes for both the UL (e.g., for transmission) and downlink (e.g., for reception) can be concurrent and/or simultaneous. The full duplex radio can include an interference management unit to reduce and or substantially eliminate self-interference via either hardware (e.g., a choke) or signal processing via a processor (e.g., a separate processor (not shown) or via processor 118). In an embodiment, the WRTU 102 can include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 can employ an E-UTRA radio technology to communicate with the WTRUs 102a, 102b, 102c over the air interface 116. The RAN 104 can also be in communication with the CN 106.

The RAN 104 can include eNode-Bs 160a, 160b, 160c, though it will be appreciated that the RAN 104 can include any number of eNode-Bs while remaining consistent with an embodiment. The eNode-Bs 160a, 160b, 160c can each include one or more transceivers for communicating with the WTRUs 102a, 102b, 102c over the air interface 116. In one embodiment, the eNode-Bs 160a, 160b, 160c can implement MIMO technology. Thus, the eNode-B 160a, for example, can use multiple antennas to transmit wireless signals to, and/or receive wireless signals from, the WTRU 102a.

Each of the eNode-Bs 160a, 160b, 160c can be associated with a particular cell (not shown) and can be configured to handle radio resource management decisions, handover decisions, scheduling of users in the UL and/or DL, and the like. As shown in FIG. 1C, the eNode-Bs 160a, 160b, 160c can communicate with one another over an X2 interface.

The CN 106 shown in FIG. 1C can include a mobility management entity (MME) 162, a serving gateway (SGW) 164, and a packet data network (PDN) gateway (or PGW) 166. While each of the foregoing elements are depicted as part of the CN 106, it will be appreciated that any of these elements can be owned and/or operated by an entity other than the CN operator.

The MME 162 can be connected to each of the eNode-Bs 162a, 162b, 162c in the RAN 104 via an S1 interface and can serve as a control node. For example, the MME 162 can be responsible for authenticating users of the WTRUs 102a, 102b, 102c, bearer activation/deactivation, selecting a particular serving gateway during an initial attach of the WTRUs 102a, 102b, 102c, and the like. The MME 162 can provide a control plane function for switching between the RAN 104 and other RANs (not shown) that employ other radio technologies, such as GSM and/or WCDMA.

The SGW 164 can be connected to each of the eNode Bs 160a, 160b, 160c in the RAN 104 via the S1 interface. The SGW 164 can generally route and forward user data packets to/from the WTRUs 102a, 102b, 102c. The SGW 164 can perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 can be connected to the PGW 166, which can provide the WTRUs 102a, 102b, 102c with access to packet-switched networks, such as the Internet 110, to facilitate communications between the WTRUs 102a, 102b, 102c and IP-enabled devices.

The CN 106 can facilitate communications with other networks. For example, the CN 106 can provide the WTRUs 102a, 102b, 102c with access to circuit-switched networks, such as the PSTN 108, to facilitate communications between the WTRUs 102a, 102b, 102c and traditional land-line communications devices. For example, the CN 106 can include, or can communicate with, an IP gateway (e.g., an IP multimedia subsystem (IMS) server) that serves as an interface between the CN 106 and the PSTN 108. In addition, the CN 106 can provide the WTRUs 102a, 102b, 102c with access to the other networks 112, which can include other wired and/or wireless networks that are owned and/or operated by other service providers.

Although the WTRU is described in FIGS. 1A-1D as a wireless terminal, it is contemplated that in certain representative embodiments that such a terminal can use (e.g., temporarily or permanently) wired communication interfaces with the communication network.

In representative embodiments, the other network 112 can be a WLAN.

A WLAN in Infrastructure Basic Service Set (BSS) mode can have an Access Point (AP) for the BSS and one or more stations (STAs) associated with the AP. The AP can have an access or an interface to a Distribution System (DS) or another type of wired/wireless network that carries traffic in to and/or out of the BSS. Traffic to STAs that originates from outside the BSS can arrive through the AP and can be delivered to the STAs. Traffic originating from STAs to destinations outside the BSS can be sent to the AP to be delivered to respective destinations. Traffic between STAs within the BSS can be sent through the AP, for example, where the source STA can send traffic to the AP and the AP can deliver the traffic to the destination STA. The traffic between STAs within a BSS can be considered and/or referred to as peer-to-peer traffic. The peer-to-peer traffic can be sent between (e.g., directly between) the source and destination STAs with a direct link setup (DLS). In certain representative embodiments, the DLS can use an 802.11e DLS or an 802.11z tunneled DLS (TDLS). A WLAN using an Independent BSS (IBSS) mode may not have an AP, and the STAs (e.g., all of the STAs) within or using the IBSS can communicate directly with each other. The IBSS mode of communication can sometimes be referred to herein as an “ad-hoc” mode of communication.

When using the 802.11ac infrastructure mode of operation or a similar mode of operations, the AP can transmit a beacon on a fixed channel, such as a primary channel. The primary channel can be a fixed width (e.g., 20 MHz wide bandwidth) or a dynamically set width via signaling. The primary channel can be the operating channel of the BSS and can be used by the STAs to establish a connection with the AP. In certain representative embodiments, Carrier Sense Multiple Access with Collision Avoidance (CSMA/CA) can be implemented, for example in 802.11 systems. For CSMA/CA, the STAs (e.g., every STA), including the AP, can sense the primary channel. If the primary channel is sensed/detected and/or determined to be busy by a particular STA, the particular STA can back off. One STA (e.g., only one station) can transmit at any given time in a given BSS.

High Throughput (HT) STAs can use a 40 MHz wide channel for communication, for example, via a combination of the primary 20 MHz channel with an adjacent or nonadjacent 20 MHz channel to form a 40 MHz wide channel.

Very High Throughput (VHT) STAs can support 20 MHz, 40 MHz, 80 MHz, and/or 160 MHz wide channels. The 40 MHz, and/or 80 MHz, channels can be formed by combining contiguous 20 MHz channels. A 160 MHz channel can be formed by combining 8 contiguous 20 MHz channels, or by combining two non-contiguous 80 MHz channels, which can be referred to as an 80+80 configuration. For the 80+80 configuration, the data, after channel encoding, can be passed through a segment parser that can divide the data into two streams. Inverse Fast Fourier Transform (IFFT) processing, and time domain processing, can be done on each stream separately. The streams can be mapped on to the two 80 MHz channels, and the data can be transmitted by a transmitting STA. At the receiver of the receiving STA, the above described operation for the 80+80 configuration can be reversed, and the combined data can be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah can support Meter Type Control/Machine-Type Communications, such as MTC devices in a macro coverage area. MTC devices can have certain capabilities, for example, limited capabilities including support for (e.g., only support for) certain and/or limited bandwidths. The MTC devices can include a battery with a battery life above a threshold (e.g., to maintain a very long battery life).

WLAN systems, which can support multiple channels, and channel bandwidths, such as 802.11n, 802.11ac, 802.11af, and 802.11ah, include a channel which can be designated as the primary channel. The primary channel can have a bandwidth equal to the largest common operating bandwidth supported by all STAs in the BSS. The bandwidth of the primary channel can be set and/or limited by a STA, from among all STAs in operating in a BSS, which supports the smallest bandwidth operating mode. In the example of 802.11ah, the primary channel can be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings can depend on the status of the primary channel. If the primary channel is busy, for example, due to a STA (which supports only a 1 MHz operating mode), transmitting to the AP, the entire available frequency bands can be considered busy even though a majority of the frequency bands remains idle and can be available.

In the United States, the available frequency bands, which can be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 can employ an NR radio technology to communicate with the WTRUs 102a, 102b, 102c over the air interface 116. The RAN 113 can also be in communication with the CN 115.

The RAN 113 can include gNBs 180a, 180b, 180c, though it will be appreciated that the RAN 113 can include any number of gNBs while remaining consistent with an embodiment. The gNBs 180a, 180b, 180c can each include one or more transceivers for communicating with the WTRUs 102a, 102b, 102c over the air interface 116. In one embodiment, the gNBs 180a, 180b, 180c can implement MIMO technology. For example, gNBs 180a, 108b can utilize beamforming to transmit signals to and/or receive signals from the gNBs 180a, 180b, 180c. Thus, the gNB 180a, for example, can use multiple antennas to transmit wireless signals to, and/or receive wireless signals from, the WTRU 102a. In an embodiment, the gNBs 180a, 180b, 180c can implement carrier aggregation technology. For example, the gNB 180a can transmit multiple component carriers to the WTRU 102a (not shown). A subset of these component carriers can be on unlicensed spectrum while the remaining component carriers can be on licensed spectrum. In an embodiment, the gNBs 180a, 180b, 180c can implement Coordinated Multi-Point (COMP) technology. For example, WTRU 102a can receive coordinated transmissions from gNB 180a and gNB 180b (and/or gNB 180c).

The WTRUs 102a, 102b, 102c can communicate with gNBs 180a, 180b, 180c using transmissions associated with a scalable numerology. For example, the OFDM symbol spacing and/or OFDM subcarrier spacing can vary for different transmissions, different cells, and/or different portions of the wireless transmission spectrum. The WTRUs 102a, 102b, 102c can communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c can be configured to communicate with the WTRUs 102a, 102b, 102c in a standalone configuration and/or a non-standalone configuration. In the standalone configuration, WTRUs 102a, 102b, 102c can communicate with gNBs 180a, 180b, 180c without also accessing other RANs (e.g., such as eNode-Bs 160a, 160b, 160c). In the standalone configuration, WTRUs 102a, 102b, 102c can utilize one or more of gNBs 180a, 180b, 180c as a mobility anchor point. In the standalone configuration, WTRUs 102a, 102b, 102c can communicate with gNBs 180a, 180b, 180c using signals in an unlicensed band. In a non-standalone configuration WTRUs 102a, 102b, 102c can communicate with/connect to gNBs 180a, 180b, 180c while also communicating with/connecting to another RAN such as eNode-Bs 160a, 160b, 160c. For example, WTRUs 102a, 102b, 102c can implement DC principles to communicate with one or more gNBs 180a, 180b, 180c and one or more eNode-Bs 160a, 160b, 160c substantially simultaneously. In the non-standalone configuration, eNode-Bs 160a, 160b, 160c can serve as a mobility anchor for WTRUs 102a, 102b, 102c and gNBs 180a, 180b, 180c can provide additional coverage and/or throughput for servicing WTRUs 102a, 102b, 102c.

Each of the gNBs 180a, 180b, 180c can be associated with a particular cell (not shown) and can be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c can communicate with one another over an Xn interface.

The CN 115 shown in FIG. 1D can include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements can be owned and/or operated by an entity other than the CN operator.

The AMF 182a, 182b can be connected to one or more of the gNBs 180a, 180b, 180c in the RAN 113 via an N2 interface and can serve as a control node. For example, the AMF 182a, 182b can be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing can be used by the AMF 182a, 182b in order to customize CN support for WTRUs 102a, 102b, 102c based on the types of services being utilized WTRUs 102a, 102b, 102c. For example, different network slices can be established for different use cases such as services relying on ultra-reliable low latency (URLLC) access, services relying on enhanced massive mobile broadband (eMBB) access, services for machine type communication (MTC) access, and/or the like. The AMF 162 can provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b can be connected to an AMF 182a, 182b in the CN 115 via an N11 interface. The SMF 183a, 183b can also be connected to a UPF 184a, 184b in the CN 115 via an N4 interface. The SMF 183a, 183b can select and control the UPF 184a, 184b and configure the routing of traffic through the UPF 184a, 184b. The SMF 183a, 183b can perform other functions, such as managing and allocating UE IP address, managing PDU sessions, controlling policy enforcement and QoS, providing downlink data notifications, and the like. A PDU session type can be IP-based, non-IP based, Ethernet-based, and the like.

The UPF 184a, 184b can be connected to one or more of the gNBs 180a, 180b, 180c in the RAN 113 via an N3 interface, which can provide the WTRUs 102a, 102b, 102c with access to packet-switched networks, such as the Internet 110, to facilitate communications between the WTRUs 102a, 102b, 102c and IP-enabled devices. The UPF 184, 184b can perform other functions, such as routing and forwarding packets, enforcing user plane policies, supporting multi-homed PDU sessions, handling user plane QoS, buffering downlink packets, providing mobility anchoring, and the like.

The CN 115 can facilitate communications with other networks. For example, the CN 115 can include, or can communicate with, an IP gateway (e.g., an IP multimedia subsystem (IMS) server) that serves as an interface between the CN 115 and the PSTN 108. In addition, the CN 115 can provide the WTRUs 102a, 102b, 102c with access to the other networks 112, which can include other wired and/or wireless networks that are owned and/or operated by other service providers. In one embodiment, the WTRUs 102a, 102b, 102c can be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, can be performed by one or more emulation devices (not shown). The emulation devices can be one or more devices configured to emulate one or more, or all, of the functions described herein. For example, the emulation devices can be used to test other devices and/or to simulate network and/or WTRU functions.

The emulation devices can be designed to implement one or more tests of other devices in a lab environment and/or in an operator network environment. For example, the one or more emulation devices can perform the one or more, or all, functions while being fully or partially implemented and/or deployed as part of a wired and/or wireless communication network in order to test other devices within the communication network. The one or more emulation devices can perform the one or more, or all, functions while being temporarily implemented/deployed as part of a wired and/or wireless communication network. The emulation device can be directly coupled to another device for purposes of testing and/or can perform testing using over-the-air wireless communications.

The one or more emulation devices can perform the one or more, including all, functions while not being implemented/deployed as part of a wired and/or wireless communication network. For example, the emulation devices can be utilized in a testing scenario in a testing laboratory and/or a non-deployed (e.g., testing) wired and/or wireless communication network in order to implement testing of one or more components. The one or more emulation devices can be test equipment. Direct RF coupling and/or wireless communications via RF circuitry (e.g., which can include one or more antennas) can be used by the emulation devices to transmit and/or receive data.

This application describes a variety of aspects, including tools, features, examples, models, approaches, etc. Many of these aspects are described with specificity and, at least to show the individual characteristics, are often described in a manner that can sound limiting. However, this is for purposes of clarity in description, and does not limit the application or scope of those aspects. Indeed, all of the different aspects can be combined and interchanged to provide further aspects. Moreover, the aspects can be combined and interchanged with aspects described in earlier filings as well.

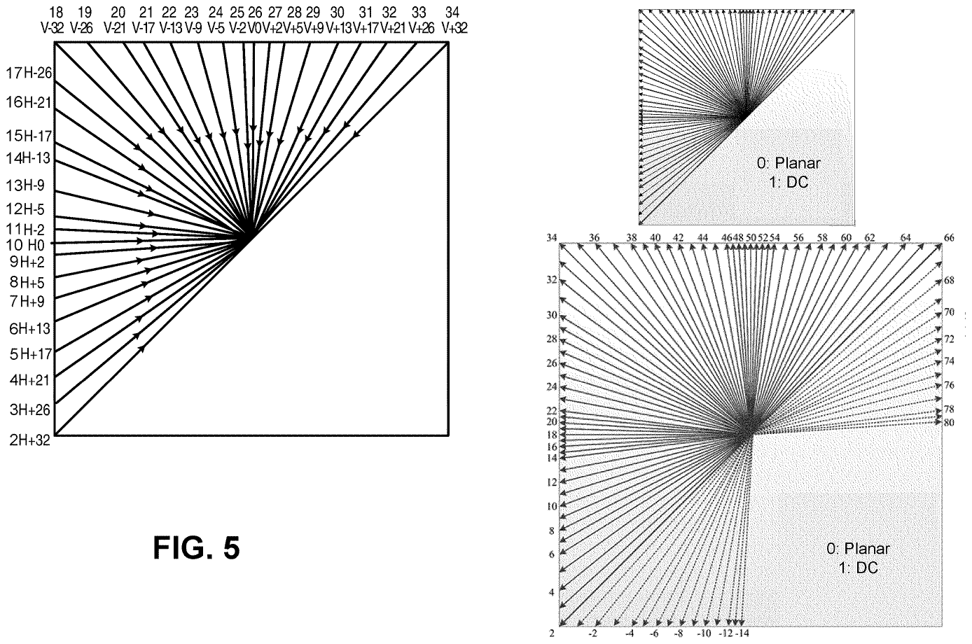

The aspects described and contemplated in this application can be implemented in many different forms. FIGS. 5-8 described herein can provide some examples, but other examples are contemplated. The discussion of FIGS. 5-8 does not limit the breadth of the implementations. At least one of the aspects generally relates to video encoding and decoding, and at least one other aspect generally relates to generating a bitstream, storing a bitstream, and/or transmitting a bitstream generated or encoded. These and other aspects can be implemented as a method, an apparatus, a computer readable storage medium having stored thereon instructions for encoding or decoding video data according to any of the methods described, and/or a computer readable storage medium having stored thereon a bitstream generated according to any of the methods described. As used herein, a bitstream may or may not be transmitted.

In the present application, the terms “reconstructed” and “decoded” can be used interchangeably, the terms “pixel” and “sample” can be used interchangeably, the terms “image,” “picture” and “frame” can be used interchangeably.

Various methods are described herein, and each of the methods comprises one or more steps or actions for achieving the described method. Unless a specific order of steps or actions is required for proper operation of the method, the order and/or use of specific steps and/or actions can be modified or combined. Additionally, terms such as “first”, “second”, etc. can be used in various examples to modify an element, component, step, operation, etc., such as, for example, a “first decoding” and a “second decoding”. Use of such terms does not imply an ordering to the modified operations unless specifically required. So, in this example, the first decoding need not be performed before the second decoding, and can occur, for example, before, during, or in an overlapping time period with the second decoding.

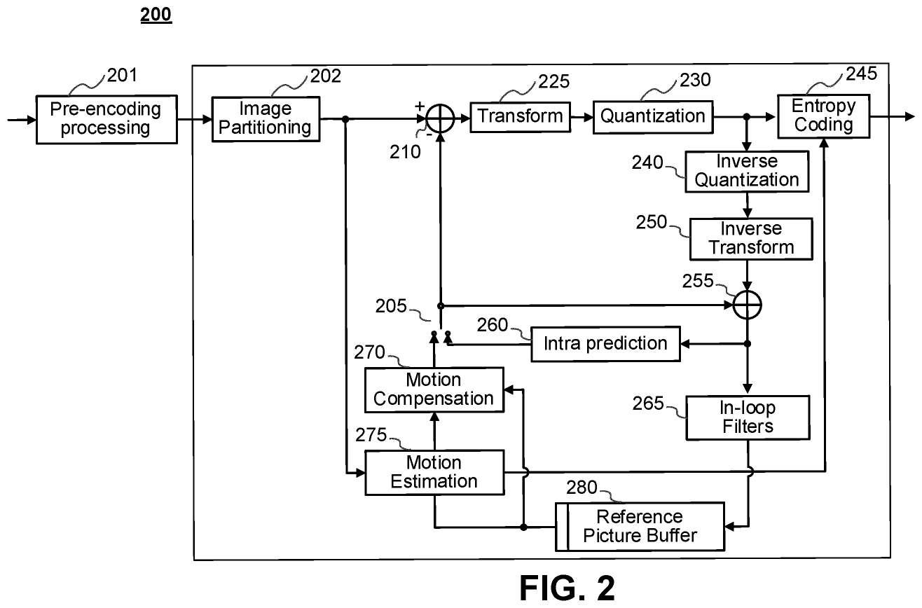

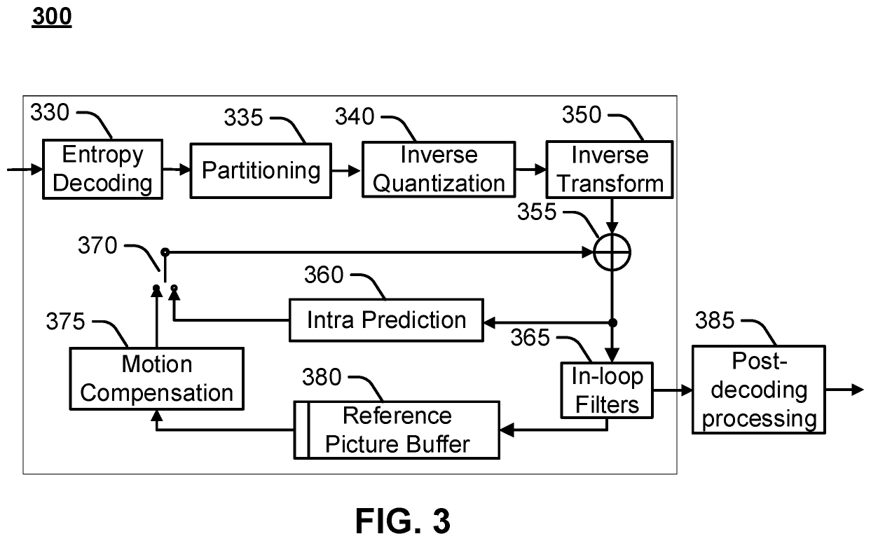

Various methods and other aspects described in this application can be used to modify modules, for example, decoding modules, of a video encoder 200 and decoder 300 as shown in FIG. 2 and FIG. 3. Moreover, the subject matter disclosed herein can be applied, for example, to any type, format or version of video coding, whether described in a standard or a recommendation, whether pre-existing or future-developed, and extensions of any such standards and recommendations. Unless indicated otherwise, or technically precluded, the aspects described in this application can be used individually or in combination.

Various numeric values are used in examples described the present application, such as 0, 1, 2, 3, 4, 6, 7, 8, 11, 16, 18, 26, 33, 45, 50, 64, 65, 66, 67, 80, 129, 131, 135, 1456, etc. These and other specific values are for purposes of describing examples and the aspects described are not limited to these specific values.

FIG. 2 illustrates an example of a d video encoder 200 (e.g., a block based hybrid video encoder). Variations of example encoder 200 are contemplated, but the encoder 200 is described below for purposes of clarity without describing all expected variations.

Before being encoded, the video sequence may go through a pre-encoding processing (201), for example, by doing one or more of applying a color transform to an input color picture (e.g., converting from RGB 4:4:4 to YCbCr 4:2:0) or performing a remapping of input picture components, for example, in order to obtain a transmission distribution that is resilient (e.g., more resilient) to compression (e.g., using a histogram equalization of one of the color components). Metadata may be associated with pre-processing and may be attached to the bitstream.

In the encoder 200, a picture may be encoded (e.g., may be encoded by the encoder elements) as described below. The picture to be encoded may be partitioned (202) and processed in units of, for example, CUs (Coding Units). Each unit may be encoded using, for example, either an intra mode or an inter mode. When a unit is encoded in an intra mode, intra prediction (260) may be performed. In an inter mode, motion estimation (275) and motion compensation (270) may be performed. The encoder may determine (205) whether one of intra mode or inter mode will be used for encoding the CU, the intra/inter decision may be indicated (e.g., by the encoder), for example, by a prediction mode indicator (e.g., a prediction mode flag). Prediction residuals may be calculated, for example, by subtracting (210) the predicted block from the original image block. In intra frames, CUs may be intra-predicted (e.g., in intra (I) frames) whereas in inter frames, a CU may be either intra-predicted or inter-predicted.

Prediction residuals may be transformed at 225 and quantized at 230. One or more of the quantized transform coefficients motion vectors, or other syntax elements (e.g., the picture partitioning information) may be entropy coded at 245 to output a bitstream. The encoder may apply quantization directly (e.g., and skip the transform) to the non-transformed residual transmission. The transform and quantization may be bypassed (e.g., by the encoder). For example, the residual may be coded (e.g., coded directly without the application of the transform or quantization processes).

An encoded block may be decoded (e.g., by the encoder) to provide a reference (e.g., a reference for further predictions). The quantized transform coefficients may be de-quantized at 240 and inverse transformed at 250 (e.g., inverse transformed to decode prediction residuals). The decoded prediction residuals and the predicted block may be combined at 255, and an image block may be reconstructed. In-loop filters at 265 may be applied to the reconstructed picture to perform, for example, deblocking/SAO (Sample Adaptive Offset)/ALF (Adaptive Loop Filter) filtering (e.g., to reduce encoding artifacts). The filtered image may be stored in a reference picture buffer at 280.

FIG. 3 illustrates a block diagram of an example video decoder 300. In the decoder 300, a bitstream may be decoded (e.g., by the decoder elements) as described herein. Video decoder 300 may perform a decoding pass reciprocal to the encoding pass as described in FIG. 2. As stated herein, the encoder 200 may perform video decoding as part of encoding video data.

In particular, the input of the video decoder may include video data (e.g., a video bitstream), which may be generated by the video encoder 200. The bitstream may be entropy decoded at 330 (e.g., to obtain one or more transform coefficients, prediction modes, motion vectors, or other coded information). The picture partition information may indicate how the picture is partitioned. The decoder may divide the picture according to the decoded picture partitioning information at 355. The transform coefficients may be de-quantized at 340 and inverse transformed at 350 to decode the prediction residuals. The predicted block may be obtained at 370 from intra prediction at 360 or motion-compensated prediction (e.g., inter prediction) at 375. The decoded prediction residuals and the predicted block may be combined at 355, and an image block may be reconstructed. In-loop filters may be applied to the reconstructed image at 365. The filtered image may be stored at a reference picture buffer at 380. The contents of the reference picture buffer 380 on the decoder side may be identical (e.g., for a picture) to the contents of the reference picture buffer 280 on the encoder 200 side.

The decoded picture may further go through post-decoding processing at 385, for example, one or more of an inverse color transform (e.g., conversion from YCbCr 4:2:0 to RGB 4:4:4) or an inverse remapping (e.g., performing the inverse of the remapping technique performed in the pre-encoding processing at 201). The post-decoding processing may use metadata derived in the pre-encoding processing and may be signaled in video data (e.g., the bitstream). In an example, the decoded images (e.g., after application of the in-loop filters 365 and/or after post-decoding processing 385, if post-decoding processing is used) may be sent to a display device for rendering to a user.

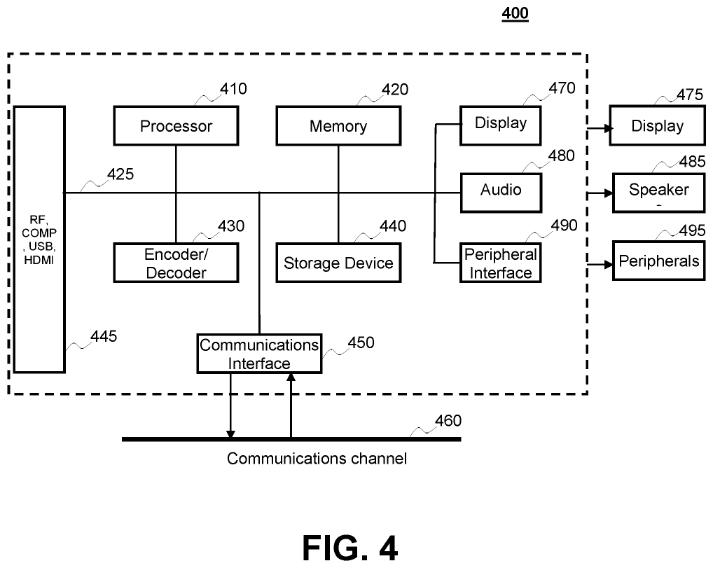

FIG. 4 is a diagram showing an example of a system in which various aspects and examples described herein can be implemented. System 400 can be embodied as a device including the various components described below and is configured to perform one or more of the aspects described in this document. Examples of such devices, include, but are not limited to, various electronic devices such as personal computers, laptop computers, smartphones, tablet computers, digital multimedia set top boxes, digital television receivers, personal video recording systems, connected home appliances, and servers. Elements of system 400, singly or in combination, can be embodied in a single integrated circuit (IC), multiple ICs, and/or discrete components. For example, in at least one example, the processing and encoder/decoder elements of system 400 are distributed across multiple ICs and/or discrete components. In various examples, the system 400 is communicatively coupled to one or more other systems, or other electronic devices, via, for example, a communications bus or through dedicated input and/or output ports. In various examples, the system 400 is configured to implement one or more of the aspects described in this document.

The system 400 includes at least one processor 410 configured to execute instructions loaded therein for implementing, for example, the various aspects described in this document. Processor 410 can include embedded memory, input output interface, and various other circuitries as known in the art. The system 400 includes at least one memory 420 (e.g., a volatile memory device, and/or a non-volatile memory device). System 400 includes a storage device 440, which can include non-volatile memory and/or volatile memory, including, but not limited to, Electrically Erasable Programmable Read-Only Memory (EEPROM), Read-Only Memory (ROM), Programmable Read-Only Memory (PROM), Random Access Memory (RAM), Dynamic Random Access Memory (DRAM), Static Random Access Memory (SRAM), flash, magnetic disk drive, and/or optical disk drive. The storage device 440 can include an internal storage device, an attached storage device (including detachable and non-detachable storage devices), and/or a network accessible storage device, as non-limiting examples.

System 400 includes an encoder/decoder module 430 configured, for example, to process data to provide an encoded video or decoded video, and the encoder/decoder module 430 can include its own processor and memory. The encoder/decoder module 430 represents module(s) that can be included in a device to perform the encoding and/or decoding functions. As is known, a device can include one or both of the encoding and decoding modules. Additionally, encoder/decoder module 430 can be implemented as a separate element of system 400 or can be incorporated within processor 410 as a combination of hardware and software as known to those skilled in the art.

Program code to be loaded onto processor 410 or encoder/decoder 430 to perform the various aspects described in this document can be stored in storage device 440 and subsequently loaded onto memory 420 for execution by processor 410. In accordance with various examples, one or more of processor 410, memory 420, storage device 440, and encoder/decoder module 430 can store one or more of various items during the performance of the processes described in this document. Such stored items can include, but are not limited to, the input video, the decoded video or portions of the decoded video, the bitstream, matrices, variables, and intermediate or final results from the processing of equations, formulas, operations, and operational logic.

In some examples, memory inside of the processor 410 and/or the encoder/decoder module 430 is used to store instructions and to provide working memory for processing that is needed during encoding or decoding. In other examples, however, a memory external to the processing device (for example, the processing device can be either the processor 410 or the encoder/decoder module 430) is used for one or more of these functions. The external memory can be the memory 420 and/or the storage device 440, for example, a dynamic volatile memory and/or a non-volatile flash memory. In several examples, an external non-volatile flash memory is used to store the operating system of, for example, a television. In at least one example, a fast external dynamic volatile memory such as a RAM is used as working memory for video encoding and decoding operations.

The input to the elements of system 400 can be provided through various input devices as indicated in block 445. Such input devices include, but are not limited to, (i) a radio frequency (RF) portion that receives an RF signal transmitted, for example, over the air by a broadcaster, (ii) a Component (COMP) input terminal (or a set of COMP input terminals), (iii) a Universal Serial Bus (USB) input terminal, and/or (iv) a High Definition Multimedia Interface (HDMI) input terminal. Other examples, not shown in FIG. 4, include composite video.

In various examples, the input devices of block 445 have associated respective input processing elements as known in the art. For example, the RF portion can be associated with elements suitable for (i) selecting a desired frequency (also referred to as selecting a signal, or band-limiting a signal to a band of frequencies), (ii) downconverting the selected signal, (iii) band-limiting again to a narrower band of frequencies to select (for example) a signal frequency band which can be referred to as a channel in certain examples, (iv) demodulating the downconverted and band-limited signal, (v) performing error correction, and/or (vi) demultiplexing to select the desired stream of data packets. The RF portion of various examples includes one or more elements to perform these functions, for example, frequency selectors, signal selectors, band-limiters, channel selectors, filters, downconverters, demodulators, error correctors, and demultiplexers. The RF portion can include a tuner that performs various of these functions, including, for example, downconverting the received signal to a lower frequency (for example, an intermediate frequency or a near-baseband frequency) or to baseband. In one set-top box example, the RF portion and its associated input processing element receives an RF signal transmitted over a wired (for example, cable) medium, and performs frequency selection by filtering, downconverting, and filtering again to a desired frequency band. Various examples rearrange the order of the above-described (and other) elements, remove some of these elements, and/or add other elements performing similar or different functions. Adding elements can include inserting elements in between existing elements, such as, for example, inserting amplifiers and an analog-to-digital converter. In various examples, the RF portion includes an antenna.

The USB and/or HDMI terminals can include respective interface processors for connecting system 400 to other electronic devices across USB and/or HDMI connections. It is to be understood that various aspects of input processing, for example, Reed-Solomon error correction, can be implemented, for example, within a separate input processing IC or within processor 410 as necessary. Similarly, aspects of USB or HDMI interface processing can be implemented within separate interface ICs or within processor 410 as necessary. The demodulated, error corrected, and demultiplexed stream is provided to various processing elements, including, for example, processor 410, and encoder/decoder 430 operating in combination with the memory and storage elements to process the datastream as necessary for presentation on an output device.

Various elements of system 400 can be provided within an integrated housing, Within the integrated housing, the various elements can be interconnected and transmit data therebetween using suitable connection arrangement 425, for example, an internal bus as known in the art, including the Inter-IC (I2C) bus, wiring, and printed circuit boards.

The system 400 includes communication interface 450 that enables communication with other devices via communication channel 460. The communication interface 450 can include, but is not limited to, a transceiver configured to transmit and to receive data over communication channel 460. The communication interface 450 can include, but is not limited to, a modem or network card and the communication channel 460 can be implemented, for example, within a wired and/or a wireless medium.

Data is streamed, or otherwise provided, to the system 400, in various examples, using a wireless network such as a Wi-Fi network, for example IEEE 802.11 (IEEE refers to the Institute of Electrical and Electronics Engineers). The Wi-Fi signal of these examples is received over the communications channel 460 and the communications interface 450 which are adapted for Wi-Fi communications. The communications channel 460 of these examples is typically connected to an access point or router that provides access to external networks including the Internet for allowing streaming applications and other over-the-top communications. Other examples provide streamed data to the system 400 using a set-top box that delivers the data over the HDMI connection of the input block 445. Still other examples provide streamed data to the system 400 using the RF connection of the input block 445. As indicated above, various examples provide data in a non-streaming manner. Additionally, various examples use wireless networks other than Wi-Fi, for example a cellular network or a Bluetooth® network.

The system 400 can provide an output signal to various output devices, including a display 475, speakers 485, and other peripheral devices 495. The display 475 of various examples includes one or more of, for example, a touchscreen display, an organic light-emitting diode (OLED) display, a curved display, and/or a foldable display. The display 475 can be for a television, a tablet, a laptop, a cell phone (mobile phone), or other device. The display 475 can also be integrated with other components (for example, as in a smart phone), or separate (for example, an external monitor for a laptop). The other peripheral devices 495 include, in various examples, one or more of a stand-alone digital video disc (or digital versatile disc) (DVD, for both terms), a disk player, a stereo system, and/or a lighting system. Various examples use one or more peripheral devices 495 that provide a function based on the output of the system 400. For example, a disk player performs the function of playing the output of the system 400.

In various examples, control signals are communicated between the system 400 and the display 475, speakers 485, or other peripheral devices 495 using signaling such as AV.Link, Consumer Electronics Control (CEC), or other communications protocols that enable device-to-device control with or without user intervention. The output devices can be communicatively coupled to system 400 via dedicated connections through respective interfaces 470, 480, and 490. Alternatively, the output devices can be connected to system 400 using the communications channel 460 via the communications interface 450. The display 475 and speakers 485 can be integrated in a single unit with the other components of system 400 in an electronic device such as, for example, a television. In various examples, the display interface 470 includes a display driver, such as, for example, a timing controller (T Con) chip.

The display 475 and speakers 485 can alternatively be separate from one or more of the other components, for example, if the RF portion of input 445 is part of a separate set-top box. In various examples in which the display 475 and speakers 485 are external components, the output signal can be provided via dedicated output connections, including, for example, HDMI ports, USB ports, or COMP outputs.

The examples can be carried out by computer software implemented by the processor 410 or by hardware, or by a combination of hardware and software. As a non-limiting example, the examples can be implemented by one or more integrated circuits. The memory 420 can be of any type appropriate to the technical environment and can be implemented using any appropriate data storage technology, such as optical memory devices, magnetic memory devices, semiconductor-based memory devices, fixed memory, and removable memory, as non-limiting examples. The processor 410 can be of any type appropriate to the technical environment, and can encompass one or more of microprocessors, general purpose computers, special purpose computers, and processors based on a multi-core architecture, as non-limiting examples.

Various implementations involve decoding. “Decoding”, as used in this application, can encompass all or part of the processes performed, for example, on a received encoded sequence in order to produce a final output suitable for display. In various examples, such processes include one or more of the processes typically performed by a decoder, for example, entropy decoding, inverse quantization, inverse transformation, and differential decoding. In various examples, such processes also, or alternatively, include processes performed by a decoder of various implementations described in this application, for example, receiving, for a video block, an indication of a first intra prediction mode associated with a first resolution; based on the first intra prediction mode, identifying a second intra prediction mode associated with a second resolution; evaluating the first intra prediction mode and the second intra prediction mode on a template of the video block; selecting, among the first intra prediction mode and the second intra prediction mode, a refined intra prediction mode for the video block; and decoding the video block based on the refined intra prediction mode.

As further examples, in one example “decoding” refers only to entropy decoding, in another example “decoding” refers only to differential decoding, and in another example “decoding” refers to a combination of entropy decoding and differential decoding. Whether the phrase “decoding process” is intended to refer specifically to a subset of operations or generally to the broader decoding process will be clear based on the context of the specific descriptions and is believed to be well understood by those skilled in the art.

Various implementations involve encoding. In an analogous way to the above discussion about “decoding”, “encoding” as used in this application can encompass all or part of the processes performed, for example, on an input video sequence in order to produce an encoded bitstream. In various examples, such processes include one or more of the processes typically performed by an encoder, for example, partitioning, differential encoding, transformation, quantization, and entropy encoding. In various examples, such processes also, or alternatively, include processes performed by an encoder of various implementations described in this application, for example, determining, for a video block, a first intra prediction mode associated with a first resolution; based on the first intra prediction mode, identifying a second intra prediction mode associated with a second resolution; evaluating the first intra prediction mode and the second intra prediction mode on a template of the video block; selecting, among the first intra prediction mode and the second intra prediction mode, a refined intra prediction mode for the video block; including an indication in video data of the first intra prediction mode; and encoding the video block based on the refined intra prediction mode.

As further examples, in one example “encoding” refers only to entropy encoding, in another example “encoding” refers only to differential encoding, and in another example “encoding” refers to a combination of differential encoding and entropy encoding. Whether the phrase “encoding process” is intended to refer specifically to a subset of operations or generally to the broader encoding process will be clear based on the context of the specific descriptions and is believed to be well understood by those skilled in the art.

Note that syntax elements as used herein, for example, coding syntax on templates, coding blocks, reference samples, refinement values, resolution factors, scores, modes (e.g., prediction modes, intra modes), number of partition modes, number of intra prediction mode candidates, number of partition mode candidates, block size, slice type, etc., are descriptive terms. As such, they do not preclude the use of other syntax element names.

When a figure is presented as a flow diagram, it should be understood that it also provides a block diagram of a corresponding apparatus. Similarly, when a figure is presented as a block diagram, it should be understood that it also provides a flow diagram of a corresponding method/process.

The implementations and aspects described herein can be implemented in, for example, a method or a process, an apparatus, a software program, a data stream, or a signal. Even if only discussed in the context of a single form of implementation (for example, discussed only as a method), the implementation of features discussed can also be implemented in other forms (for example, an apparatus or program). An apparatus can be implemented in, for example, appropriate hardware, software, and firmware. The methods can be implemented in, for example, a processor, which refers to processing devices in general, including, for example, a computer, a microprocessor, an integrated circuit, or a programmable logic device. Processors also include communication devices, such as, for example, computers, cell phones, portable/personal digital assistants (“PDAs”), and other devices that facilitate communication of information between end-users.

Reference to “one example” or “an example” or “one implementation” or “an implementation”, as well as other variations thereof, means that a particular feature, structure, characteristic, and so forth described in connection with the example is included in at least one example. Thus, the appearances of the phrase “in one example” or “in an example” or “in one implementation” or “in an implementation”, as well any other variations, appearing in various places throughout this application are not necessarily all referring to the same example.

Additionally, this application can refer to “determining” various pieces of information. Determining the information can include one or more of, for example, estimating the information, calculating the information, predicting the information, or retrieving the information from memory. Obtaining can include receiving, retrieving, constructing, generating, and/or determining.

Further, this application can refer to “accessing” various pieces of information. Accessing the information can include one or more of, for example, receiving the information, retrieving the information (for example, from memory), storing the information, moving the information, copying the information, calculating the information, determining the information, predicting the information, or estimating the information.

Additionally, this application can refer to “receiving” various pieces of information. Receiving is, as with “accessing”, intended to be a broad term. Receiving the information can include one or more of, for example, accessing the information, or retrieving the information (for example, from memory). Further, “receiving” is typically involved, in one way or another, during operations such as, for example, storing the information, processing the information, transmitting the information, moving the information, copying the information, erasing the information, calculating the information, determining the information, predicting the information, or estimating the information.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This can be extended, as is clear to one of ordinary skill in this and related arts, for as many items as are listed.

Also, as used herein, the word “signal” refers to, among other things, indicating something to a corresponding decoder. Encoder signals can include, for example, intra prediction mode candidates, number of partition mode candidates, block size, slice type, etc. In this way, in an example the same parameter is used at both the encoder side and the decoder side. Thus, for example, an encoder can transmit (explicit signaling) a particular parameter to the decoder so that the decoder can use the same particular parameter. Conversely, if the decoder already has the particular parameter as well as others, then signaling can be used without transmitting (implicit signaling) to simply allow the decoder to know and select the particular parameter. By avoiding transmission of any actual functions, a bit savings is realized in various examples. It is to be appreciated that signaling can be accomplished in a variety of ways. For example, one or more syntax elements, flags, and so forth are used to signal information to a corresponding decoder in various examples. While the preceding relates to the verb form of the word “signal”, the word “signal” can also be used herein as a noun.

As will be evident to one of ordinary skill in the art, implementations can produce a variety of signals formatted to carry information that can be, for example, stored or transmitted. The information can include, for example, instructions for performing a method, or data produced by one of the described implementations. For example, a signal can be formatted to carry the bitstream of a described example. Such a signal can be formatted, for example, as an electromagnetic wave (for example, using a radio frequency portion of spectrum) or as a baseband signal. The formatting can include, for example, encoding a data stream and modulating a carrier with the encoded data stream. The information that the signal carries can be, for example, analog or digital information. The signal can be transmitted over a variety of different wired or wireless links, as is known. The signal can be stored on, or accessed or received from, a processor-readable medium.

Many examples are described herein. Features of examples can be provided alone or in any combination, across various claim categories and types. Further, examples can include one or more of the features, devices, or aspects described herein, alone or in any combination, across various claim categories and types. For example, features described herein can be implemented in a bitstream or signal that includes information generated as described herein. The information can allow a decoder to decode a bitstream, the encoder, bitstream, and/or decoder according to any of the embodiments described. For example, features described herein can be implemented by creating and/or transmitting and/or receiving and/or decoding a bitstream or signal. For example, features described herein can be implemented a method, process, apparatus, medium storing instructions, medium storing data, or signal. For example, features described herein can be implemented by a TV, set-top box, cell phone, tablet, or other electronic device that performs decoding. The TV, set-top box, cell phone, tablet, or other electronic device can display (e.g., using a monitor, screen, or other type of display) a resulting image (e.g., an image from residual reconstruction of the video bitstream). The TV, set-top box, cell phone, tablet, or other electronic device can receive a signal including an encoded image and perform decoding.

Intra sample prediction may include predicting pixels of a target CU based on a set of reference samples. Prediction modes may include planar and DC prediction modes, which may be used to predict smooth and gradually changing regions. Angular prediction modes (e.g., an angle from 45 degrees to −135 degrees in a clockwise direction) may be used to capture directional structures. For square blocks, directional prediction modes (e.g., 33 directional modes for square blocks), which may be indexed (e.g., indexed from 2 to 34), may be used. The prediction modes may correspond to prediction directions as illustrated in the top left side of FIG. 5. Angular prediction modes may correspond to angular directions (e.g., 65 angular prediction modes may correspond to 33 angular directions), and angular directions (e.g., 32 additional angular directions) may correspond to a direction mid-way between an adjacent pair as illustrated in the top right side of FIG. 5.

The top left of FIG. 5 illustrates example intra prediction directions. A number may denote the prediction mode index associated with the corresponding direction. The modes (e.g., 2 through 17) may indicate horizontal predictions (H−26 to H+32), and the modes 18 through 34 may indicate vertical predictions (V−32 to V+32). The top right of FIG. 5 illustrates intra prediction for square blocks. Modes less than 34 may indicate horizontal predictions. Modes greater than 34 may indicate vertical predictions. The bottom of FIG. 5 illustrates available intra prediction directions. Dashed lines may indicate wide angle intra prediction modes (WAIP). The indices −1 through −14 illustrated in FIG. 5 may be remapped to go from 1 through −12 (e.g., such that angular mode indices are continuous). In some examples, modes −15 (e.g., remapped to −13) and 81 may or may not be present in FIG. 5, as block sizes (e.g., no allowed block sized) may or may not use modes −15 (e.g., remapped to −13) and 81. Modes −15 (e.g., remapped to −13) and 81 may be handled by reference code.

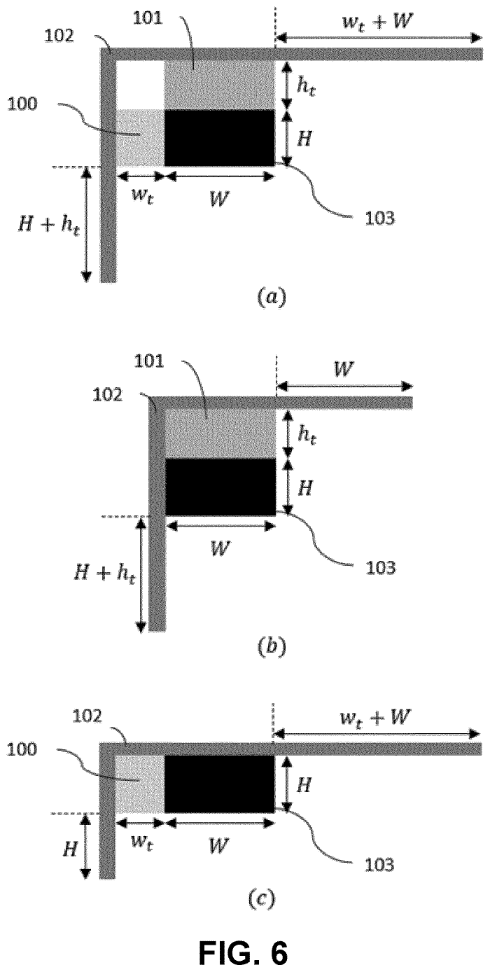

Template-based intra mode derivation (TIMD) may be performed to derive prediction mode(s) for a coding block. Intra prediction mode derivation via TIMD may be applied on encoder and decoder sides (e.g., may be applied the same way on encoder and decoder sides) for a luminance, such as CB 103 as shown in FIG. 6(a). An intra prediction mode (e.g., supplemented with default modes) in the MPM list of the luminance CB may be used to compute a prediction of the template (100 and 101) of the luminance CB from the decoded reference samples of the template (102). The sum of absolute transformed differences (SATD) between the prediction and the template of the luminance CB may be calculated. The (e.g., two) intra prediction mode(s) with the minimum (e.g., smallest) SATDs may be selected as the TIMD mode(s). The set of directional intra prediction modes (e.g., for TIMD) may be extended (e.g., from 65 to 129), for example, by inserting a direction between a solid and neighboring dashed arrow in FIG. 5. The set of possible intra prediction modes derived via TIMD may gather modes (e.g., 131 modes). After retaining intra prediction modes (e.g., two (2) intra prediction modes from the first pass of tests involving the MPM list supplemented with default modes, for a mode that is not PLANAR or DC, TIMD may test in terms pf prediction SATD its closest (e.g., two (2) closest) extended directional intra prediction mode(s). The SATD(s) between the prediction computed using the closest extended directional intra prediction mode(s) and the template of the luminance CB may be calculated. The intra prediction mode(s) with the minimum (e.g., smallest) SATDs may be selected as the TIMD mode(s).

FIG. 6 illustrates an example template of the current luminance CB and decoded reference samples of the template used in TIMD. In FIG. 6(a), the template of the luminance CB does not go out of the bounds of the current frame. The current W×H luminance CB 103 may be surrounded by its fully available template, made of a wₜ×H portion on its left side at 100 and a W×hₜ portion above it at 101. During the TIMD derivation step, a tested intra prediction mode may predict the template of the current luminance CB from the set of 1+2 wₜ+2 W+2hₜ+2H decoded reference samples 102 of the template. wₜ may equal two (2) if W≤8; otherwise, wₜ may equal 4. hₜ may equal two (2) if H≤8; otherwise hₜ may equal 4.

FIGS. 6 (b) and 6 (c) show examples where at least a (e.g., one) portion of the template of the luminance CB goes out of the bounds of the current frame. In FIG. 6 (b), the current W×H luminance CB 103 may be surrounded by its template with its W×hₜ portion above it at 101 available. During the TIMD derivation step, a tested intra prediction mode may predict the template of the current luminance CB from the set of 1+2 W+2hₜ+2H decoded reference samples at 102 of the template. In FIG. 6(c), the current W×H luminance CB 103 may be surrounded by its template with only its w×H portion on its left side at 100 available. During the TIMD derivation step, a tested intra prediction mode many predict the template of the current luminance CB from the set of 1+2 wₜ+2 W+2H decoded reference samples at 102 of the template.

The current luminance CB may be predicted via TIMD, for example, by fusing the (e.g., two) predictions of the luminance CB computed based on the (e.g., two) TIMD modes resulting from the (e.g., two) passes of tests with weights (e.g., after applying PDPC). The weights used may depend on the prediction SATDs of the (e.g., two) TIMD modes.

Decoder side intra mode derivation (DIMD) may be performed to derived intra prediction mode(s) for a coding block. In examples, two intra modes may be derived from the reconstructed neighbor samples.

The two predictors may be combined with the planar mode predictor with the weights derived from gradients. The division operations in weight derivation may be performed utilizing the same lookup table (LUT) based integerization scheme used by the cross-complaint linear model (CCLM). In examples, the division operation in the orientation calculation

$$Orient = {G}_{y} / {G}_{x}$$

may be computed by the following LUT-based scheme:

$$x = Floor ( Log 2 ( G x ) )$$

$$normDiff = ( ( Gx << 4 ) >> x ) \& 15$$

$$x += ( 3 + ( normDiff != 0 ) ? 1 : 0 )$$

$$Orient = ( {Gy}^{⋆} ( DivSigTable [ normDiff ] \vert 8 ) + ( 1 << ( x - 1 ) ) ) >> x ,$$

$$where$$

$$DivSigTable [ 16 ] = \{ 0 , 7 , 6 , 5 , 5 , 4 , 4 , 3 , 3 , 2 , 2 , 1 , 1 , 1 , 1 , 0 \} .$$

Derived intra modes may be included in the primary list of intra most probable modes (MPM), and the DIMD technique may be performed before the MPM list is constructed. The primary derived intra mode of a DIMD block may be stored with a block and may be used for MPM list construction of the neighboring blocks.

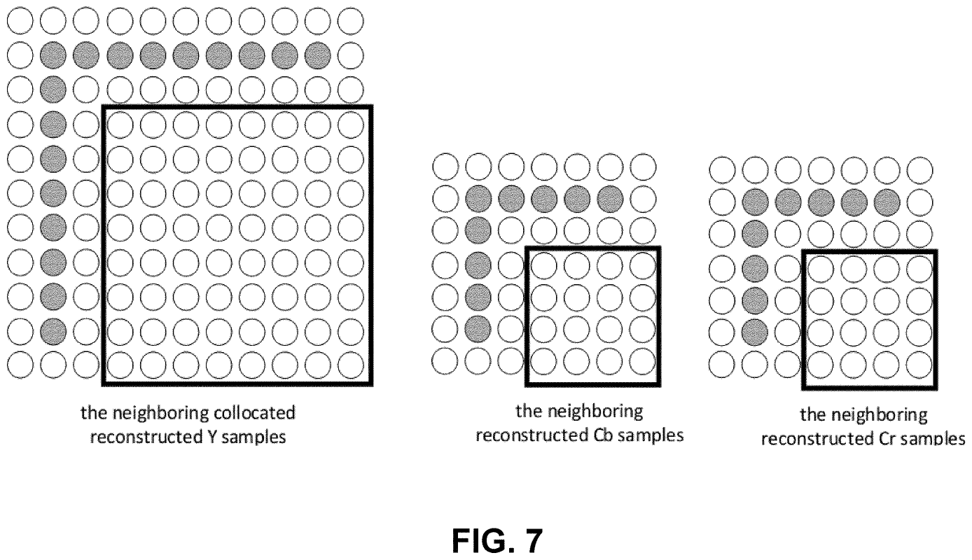

FIG. 7 illustrates neighboring reconstructed samples used for DIMD chroma mode. The DIMD chroma mode may use DIMD derivation to derive the chroma intra prediction mode of the current block based on the neighboring reconstructed Y, Cb and Cr samples in the second neighboring row and column, as shown in FIG. 7. A horizontal gradient and a vertical gradient may be calculated for a collocated reconstructed luma sample of the current chroma block, as well as the reconstructed Cb and Cr samples, to build a histogram of oriented gradients (HoG). The intra prediction mode with the largest histogram amplitude values may be used for performing chroma intra prediction of the current chroma block.

When the intra prediction mode derived from the DIMD chroma mode is the same as the intra prediction mode derived from the chroma direct mode (DM), the refined intra prediction mode may be selected. The selection may be based on a determination that the histogram amplitude value corresponding to the refined intra prediction mode is the highest (e.g., largest) histogram amplitude value among multiple histogram amplitude values (e.g., multiple candidate histogram amplitude values). The refined intra prediction mode (e.g., the highest histogram amplitude value) may be used as the DIMD chroma mode. A CU level flag may be signaled to indicate whether the DIMD chroma mode is applied.

In an example, the chroma intra prediction may use the same mode as the collocated luma prediction unit (PU). In DIMD, the derived chroma DIMD mode may be the same as the chroma direct mode (DM mode) (e.g., the same as the intra mode of the collocated luma PU), and the second mode from the histogram may be used for chroma DIMD mode (e.g., to avoid redundant coding). An indication may be signaled (e.g., by the encoder/decoder) to indicate whether the DM mode is equal to the chroma DIMD mode).

As described herein, TIMD may use extended intra directions. In examples, 131 modes may be used (e.g., instead of 65 modes). 131 modes may be used to increase the prediction quality, and a higher number of directions may lead to a finer prediction. When increasing directions, additional signaling may be used.

In examples, to use the increasing the number of directions without increasing the signaling overhead, the reconstructed block template may be used to refine the prediction direction, e.g., using the reconstructed block template. Similar techniques (e.g., the same techniques may be applied on the encoder and decoder sides.

In examples, template-based intra direction refinement may be performed (e.g., See FIG. 6). The encoder may find the best intra prediction mode and may signal the best intra prediction mode to the decoder. The signaled prediction mode resolution may be increased by inserting additional modes, (e.g., inserting additional modes between modes (e.g., between every two modes)). In examples, one angle may be inserted between modes (e.g., two modes, as in the TIMD process). The encoder and decoder may analyze the reconstructed template (e.g., to decide which mode is selected in the increased resolution).

In examples, a current resolution of intra modes may be 67. In examples, the current resolution of intra modes may include 65 angles (e.g., see FIG. 6) with planar and DC modes. In TIMD, for example, the resolution may be 131 and may include 129 angles with planar and DC modes. The resolution may be doubled in TIMD (e.g., compared to intra prediction modes that are not TIMD).

In examples involving the algorithm of refinement, the resolution increase may be described by a factor “n”. When “n” is equal to one (1), one (1) additional intra prediction angle may be inserted between two adjacent angles (e.g., every two (2) adjacent angles). When “n” is equal to two (2), two (2) additional intra prediction angles may be inserted between two (2) adjacent angles (e.g., every two (2) adjacent angles). In Table 1, “n=1” and “n=2” may be used.

TABLE 1
additional intra angular modes, represented by “x”, depending on resolution factor.

| | | | | | | | | | | | | | | | | | | | | | | | |
|---|---|---|---|---|---|---|---|---|---|---|---|---|---|---|---|---|---|---|---|---|---|---|---|
| n = 0 | Planar | DC | 0 | 1 | 2 | 3 | 4 | 5 | . . . | . . . | | | | | | | | | | | 65 | | |
| n = 1 | Planar | DC | 0 | x | 1 | x | 2 | x | 3 | x | 4 | x | 5 | . . . | . . . | | | | | | 65 | x | |
| n = 2 | Planar | DC | 0 | x | x | 1 | x | x | 2 | x | x | 3 | x | x | 4 | x | x | 5 | . . . | . . . | 65 | x | x |

In table 2, the algorithmic description for refining an intra mode is provided.

TABLE 2
Algorithmic description for refining an intra mode.

```
Algorithm: Refining Signaled Mode
Input: curIpm (current intra prediction mode), resolution factor: n
Output: refineVal (refinement value)
refineVal = Refine_Mode(curIpm, n)
  BestScore= 0
  refineVal = 0
  For i=0:n
    curScore = AnalyzeTemplate(curIpm,n, i)
    If (curScore > BestScore)
      BestScore = curScore
      refineVal = i
    End
  End
End
```

The function AnalyzeTemplate may be used to calculate a score/distance for the prediction modes in the increased resolution to favor intra prediction modes with a highest score/lowest distance.

In a DIMD based example, the form may generate a histogram of gradients on the reconstructed template to yield the best mode (e.g., the prediction quality of the best mode may be tested based on the directionality of the reconstructed template). The histogram may include the directions given by the current intra mode to (n+current intra mode). In a TIMD based example, the modes may be tested from the current mode to (n+current mode) and the prediction error of the modes may be computed (e.g., a cost of the modes may be computed).

A video coding device (e.g., a video encoding and/or decoding device) may compute a first prediction of a template of a video block based on a first intra prediction mode. The device may compute a second prediction of the template of the video block based on a second intra prediction mode. The device may obtain, based on the first and second predictions, a first prediction error and a second prediction error that correspond to the first prediction mode and the second prediction mode, respectively. The device may select the refined intra prediction mode for the video block based on one or more of the first prediction error or the second prediction error. For example, the device may compute a third prediction of the template of the video block based on the second intra prediction mode. The device may obtain, based on the first, second, and third predictions, a first, second, and third error, respectively, which correspond to first, second, and third intra prediction modes, respectively. The best mode may be the mode that minimizes the prediction error. The refined intra prediction mode may be selected based on a determination that the intra prediction error corresponding to the refined intra prediction mode is the lowest among the prediction errors. Intra mode with TIMD-based refinement may be activated at the Sequence Parameter Set (SPS) level, picture level, or slice level.

At the decoder side, the refinement technique may be used to find the second (e.g., additional) mode in the higher resolution, and the prediction may be performed.

In examples, a video coding device (e.g., a video decoding device) may receive, for a video block, an indication of an intra prediction mode associated with a first resolution (e.g., 67 resolution) The indication of the intra prediction mode associated with the first resolution may be included in video data (e.g., by an encoder). Based on the indicated intra prediction mode, the device may identify a second (e.g., additional) intra prediction mode associated with a second resolution (e.g., 131 resolution). In examples, the device may identify a third (e.g., additional) intra prediction mode associated with the second resolution (e.g., 131 resolution). The device may evaluate the first intra prediction mode and the second intra prediction mode on a template of the video block and select a refined intra prediction mode for the video block among the first intra prediction mode and the second intra prediction mode. The device may evaluate the first, second, and third intra prediction mode on a template of the video block and select a refined intra prediction mode for the video block among the first, second, and third intra prediction modes. The video block may be decoded based on the refined intra prediction mode (see FIG. 6). Extended intra prediction may be used. In examples, 131 modes may be used by refining the signaled mode (e.g., from 67 resolution) to 131 resolution (e.g., see FIG. 6). Better prediction quality may result (e.g., by having 131 resolution from 67 resolution while keeping the signaling unchanged. An example advantage may include a unified resolution for intra prediction modes in TIMD (e.g., and other modes). The resolution may be increased by a factor more than one (1). The prediction technique complexity may be proportional to the number of intra prediction modes.

Extended intra modes for DIMD may be used. In examples, DIMD may generate a histogram of directions of the available intra modes (e.g., the 65 available intra modes) by analyzing the gradients of the reconstructed template. A video coding device (e.g., a video encoding and/or decoding device) may generate a histogram of gradients on the template. The histogram may include directions associated with the first intra prediction mode and the second intra prediction mode. Among the first intra prediction mode and the second intra prediction mode (e.g., an additional intra prediction mode), the refined intra mode may be selected based on a histogram amplitude value associated with the first intra prediction mode and the second intra prediction mode. In examples, the histogram may include directions associated with the first, second, and third intra prediction mode. Among the first, second, and third intra prediction mode (e.g., the second and third intra prediction modes may be additional intra prediction modes), the refined intra mode may be selected based on a histogram amplitude value associated with the first, second, and third intra prediction mode. The resulting mode may be refined to 131 modes using the refinement technique (e.g., the TIMD based technique). The technique (e.g., the refinement) may be applied to chroma DIMD.

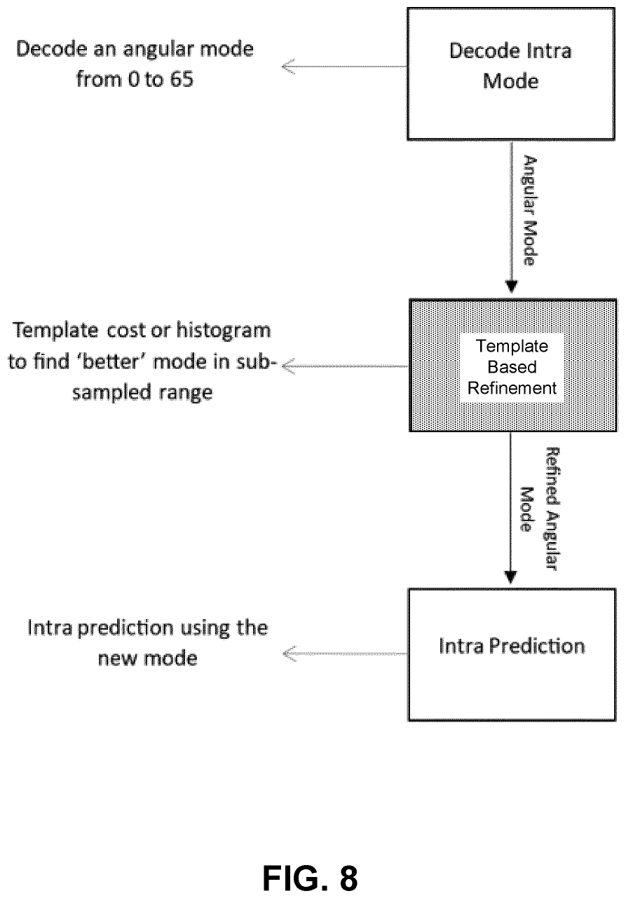

FIG. 8 illustrates an example block diagram for refinement. In examples, an intra mode may be decoded (e.g., an angular mode from 0 to 65). A template cost or histogram may be used to determine a best (e.g., better) mode in a sub-sampled range. Intra prediction may be applied using the best mode.

Although features and elements are described above in particular combinations, one of ordinary skill in the art will appreciate that each feature or element can be used alone or in any combination with the other features and elements. In addition, the methods described herein can be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software can be used to implement a radio frequency transceiver for use in a WTRU, UE, terminal, base station, RNC, or any host computer.

1-40. (canceled)

41. A video decoding device, comprising:
a processor configured to:
receive, for a video block, an indication of a first intra prediction mode associated with a first resolution;
based on the first intra prediction mode, identify a second intra prediction mode associated with a second resolution;
evaluate the first intra prediction mode and the second intra prediction mode on a template of the video block;
select, among the first intra prediction mode and the second intra prediction mode, a refined intra prediction mode for the video block; and
decode the video block based on the refined intra prediction mode.

42. The device of claim 41, wherein the processor is further configured to:
obtain a first prediction of the template of the video block based on the first intra prediction mode;
obtain a second prediction of the template of the video block based on the second intra prediction mode;
compute, based at least in part on the first and second predictions, a first prediction error that corresponds to the first intra prediction mode and a second prediction error that corresponds to the second intra prediction mode; and
select the refined intra prediction mode for the video block based on the first prediction error and the second prediction error.

43. The device of claim 42, wherein the refined intra prediction mode is selected based on a determination that a prediction error of the refined intra prediction mode is lowest among the first prediction error and the second prediction error.

44. The device of claim 41, wherein the processor is further configured to:
based on the first intra prediction mode, identify a third intra prediction mode associated with the second resolution;
evaluate the first intra prediction mode, the second intra prediction mode, and the third intra prediction mode on a template of the video block;
obtain a first prediction of the template of the video block based on the first intra prediction mode;
obtain a second prediction of the template of the video block based on the second intra prediction mode;
obtain a third prediction of the template of the video block based on the third intra prediction mode;
compute, based at least in part on the first, second, and third predictions, a first prediction error that corresponds to the first intra prediction mode, a second prediction error that corresponds to the second intra prediction mode, and a third prediction error that corresponds to the third intra prediction mode; and
select the refined intra prediction mode for the video block based on the first prediction error, the second prediction error, and the third prediction error.

45. The device of claim 44, wherein the refined intra prediction mode is selected based on a determination that a prediction error of the refined intra prediction mode is lowest among the first prediction error, the second prediction error, and the third prediction error.

46. The device of claim 41, wherein the processor is further configured to:
generate a histogram of gradients associated with the template of the video block, wherein the histogram comprises a plurality of histogram amplitude values associated with the first intra prediction mode and the second intra prediction mode; and
select, among the first intra prediction mode and the second intra prediction mode, the refined intra mode based on the plurality of histogram amplitude values.

47. The device of claim 46, wherein the refined intra prediction mode is selected based on a determination that a histogram amplitude value of the plurality of histogram amplitude values that corresponds to the refined intra prediction mode is highest among the plurality of histogram amplitude values associated with the first intra prediction mode and the second intra prediction mode.

48. The device of claim 41, wherein the processor is further configured to:
based on the first intra prediction mode, identify a third intra prediction mode associated with the second resolution;
evaluate the first intra prediction mode, the second intra prediction mode, and the third intra prediction mode on a template of the video block;
generate a histogram of gradients associated with the template of the video block, wherein the histogram comprises a plurality of histogram amplitude values associated with the first intra prediction mode, the second intra prediction mode, and the third intra prediction mode; and
select, among the first intra prediction mode, the second intra prediction mode, and the third intra prediction mode, the refined intra mode based on the plurality of histogram amplitude values.

49. The device of claim 48, wherein the refined intra prediction mode is selected based on a determination that a histogram amplitude value that corresponds to the refined intra prediction mode is highest among the plurality of histogram amplitude values associated with the first intra prediction mode, the second intra prediction mode, and the third intra prediction mode.

50. A method for a video decoding device, the method comprising:
receiving, for a video block, an indication of a first intra prediction mode associated with a first resolution;
based on the first intra prediction mode, identifying a second intra prediction mode associated with a second resolution;
evaluating the first intra prediction mode and the second intra prediction mode on a template of the video block;
selecting, among the first intra prediction mode and the second intra prediction mode, a refined intra prediction mode for the video block; and
decoding the video block based on the refined intra prediction mode.

51. The method of claim 50, wherein the method further comprises:
obtaining a first prediction of the template of the video block based on the first intra prediction mode;
obtaining a second prediction of the template of the video block based on the second intra prediction mode;
computing, based at least in part on the first and second predictions, a first prediction error that corresponds to the first intra prediction mode and a second prediction error that corresponds to the second intra prediction mode; and
selecting the refined intra prediction mode for the video block based on the first prediction error and the second prediction error.

52. The method of claim 51, wherein the refined intra prediction mode is selected based on a determination that a prediction error of the refined intra prediction mode is lowest among the first prediction error and the second prediction error.

53. The method of claim 50, wherein the method further comprises:
based on the first intra prediction mode, identifying a third intra prediction mode associated with the second resolution;
evaluating the first intra prediction mode, the second intra prediction mode, and the third intra prediction mode on a template of the video block;
obtaining a first prediction of the template of the video block based on the first intra prediction mode;
obtaining a second prediction of the template of the video block based on the second intra prediction mode;
obtaining a third prediction of the template of the video block based on the third intra prediction mode;
computing, based at least in part on the first, second, and third predictions, a first prediction error that corresponds to the first intra prediction mode, a second prediction error that corresponds to the second intra prediction mode, and a third prediction error that corresponds to the third intra prediction mode; and
selecting the refined intra prediction mode for the video block based on the first prediction error, the second prediction error, and the third prediction error.

54. The method of claim 53, wherein the refined intra prediction mode is selected based on a determination that a prediction error of the refined intra prediction mode is lowest among the first prediction error, the second prediction error, and the third prediction error.

55. The method of claim 50, wherein the method further comprises:
generating a histogram of gradients associated with the template of the video block, wherein the histogram comprises a plurality of histogram amplitude values associated with the first intra prediction mode and the second intra prediction mode; and
selecting, among the first intra prediction mode and the second intra prediction mode, the refined intra mode based on the plurality of histogram amplitude values.
